(19) United States
(12) Patent Application Publication
(10) Pub. No.: US 2015/0188648 A1
(43) Pub. Date: Jul. 2, 2015

(54) MUSIC SOURCE INFORMATION PROVIDING METHOD BY MEDIA OF VEHICLE

(71) Applicant: HYUNDAI MOTOR COMPANY, Seoul (KR)

(72) Inventor: Won-Seok YANG, Seoul (KR)

(21) Appl. No.: 14/513,116

(22) Filed: Oct. 13, 2014

(30) Foreign Application Priority Data
Dec. 30, 2013 (KR) 10-2013-167453

(51) Int. Cl. H04H 20/53

(52) U.S. Cl. CPC H04H 20/53

(57) ABSTRACT

A music source information providing method through a media provided in a vehicle includes playing a music source by a media system which is provided the vehicle. Whether or not the music source is recognized is checked by a controller. The music source is recorded by the media system when the music source is recognized. The recorded music source is transmitted to an application program by the media system. The music source is recognized by the application program. Music source information is displayed by the media system when the music source is recognized.

### CROSS-REFERENCE TO RELATED APPLICATIONS

This application claims the benefit of priority under 35 U.S.C. §119 to Korean Patent Application No. 10-2013-167453, filed on Dec. 30, 2013, in the Korean Intellectual Property Office, the disclosure of which is incorporated herein by reference in its entirety.

### TECHNICAL FIELD

The present disclosure relates to a music source information providing method, and more particularly, to a control method of a music source information providing system through media, which is provided in a vehicle, that searches and provides music source information using an internal signal of a media system in the vehicle, rather than using an external microphone.

### BACKGROUND

Generally, a vehicle includes an audio system or a music player system for a driver or a passenger to listen to music.

When the driver or the passenger listens to the music using such a system, the driver or the passenger may want to know information on a music source. To this end, a system which provides music source information has been developed.

Recently, a music source recognizing program or a music source information providing program, which is provided in the vehicle or a smart phone, recognizes a music source through an external microphone and provides music source information to a user.

However, the music source recognizing program or the music source information providing program of the related art necessarily uses the external microphone, such that not only the music source but also a noise is introduced into the microphone, thus reducing a success rate of music source recognition.

A technique of collecting a music source by using a computer is available, which changes an output from a speaker into a recording application program in the computer through a sound card and records an output audio.

Therefore, a music source recognizing program or a music source information providing program which may improve the success rate of music source recognition by lowering the noise is necessary.

### SUMMARY

An aspect of the present disclosure provides a music source information providing method in which a success rate of music source recognition is improved due to reduced introduced external noise.

Another aspect of the present disclosure provides a music source information providing method which does not need a separate music source device which records the music source to reduce a cost.

A technical object to be achieved in the present disclosure is not limited to the aforementioned technical objects, and other not-mentioned technical objects will be obviously understood by those skilled in the art from the description below.

According to an exemplary embodiment of the present disclosure, a music source information providing method through media which is provided in a vehicle is provided. The method includes playing a music source by a media system which is provided in the vehicle. Whether or not the music source is recognized is checked by a controller. The music source is recorded by the media system when recognition of the music source is checked. The recorded music source is transmitted to an application program by the media system, then the application program recognizes the music source. Music source information is displayed by the media system when the music source is recognized. The method may further include, after the step of trying, recording the music source again when the recognition of the music source fails by the media system.

The media system may include any one or more of an FM/AM/HD radio system, a USB/MP3/CD/Bluetooth music player system, and an AUX system.

The step of checking may include displaying an icon by the media system. Whether to touch the icon is checked by the media system. A music source recognition trial signal is transmitted to the controller by the media system.

The step of trying may include transmitting music source data to a music source server by the application program. Music source information is searched using the music source data by the music source server. The music source information is provided to the application program by the music source server.

The music source information may include information on at least one of a title of the music source, a name of a singer of the music source, lyrics of the music source, an album title of the music source, and a year when the music source is released.

According to the exemplary embodiments of the present disclosure, the music source recognition first uses an internal signal of a media system which is applied to a vehicle rather than using an external microphone so that external noise is prevented from being introduced, thereby improving the quality of music source recording data and increasing a success rate of music source recognition as a result.

According to the exemplary embodiments of the present disclosure, no separate music source device which records a music source is required, thereby reducing the cost, and the music source is simply recognized only by touching an icon, thereby improving usability.

### BRIEF DESCRIPTION OF THE DRAWINGS

FIG. 1 is a diagram of a music source information providing system through a media which is applied to a vehicle according to an exemplary embodiment of the present disclosure.

FIG. 2 is a flowchart of a music source information providing method through a media which is applied to a vehicle according to an exemplary embodiment of the present disclosure.

### DETAILED DESCRIPTION

Hereinafter, exemplary embodiments of the present disclosure will be described in detail with reference to the accompanying drawings. Prior to this, terms or words used in the specification and the claims should not be restrictively analyzed as a general and dictionary meaning and should be analyzed as a meaning and a concept which conform to the technical spirit of the present invention based on a principle that the inventor can appropriately define a concept of a term in order to describe his/her own invention by the most method. Therefore, the embodiments described in the present specification and configurations illustrated in the drawings are only exemplary embodiments of the present disclosure and do not represent all of the technical spirit of the present invention, and thus, it is to be understood that various equivalents and modified examples, which may replace the embodiments, are possible when filing the present application.

The present disclosure provides a music source information providing method which uses an internal signal of a media system instead of an external microphone so that noise is reduced to improve a success rate of music source recognition. The method includes a step of playing a music source by a media system 120 which is provided in a vehicle 120. Whether to try to recognize the music source is checked by a controller 110. When the music source recognizing is checked, the music source is recorded by the media system. The recorded music source is transmitted to an application program 200 by the media system. The music source is tried to me recognized by the application program. When the music source is successfully recognized, music source information is displayed by the media system.

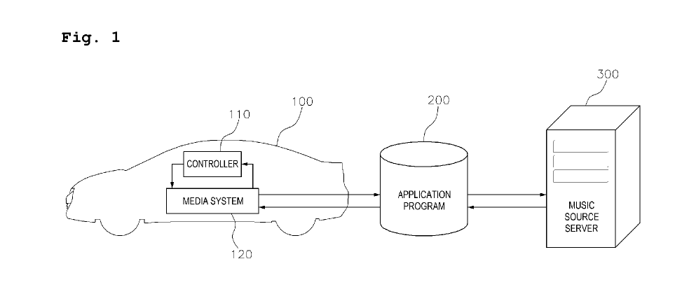

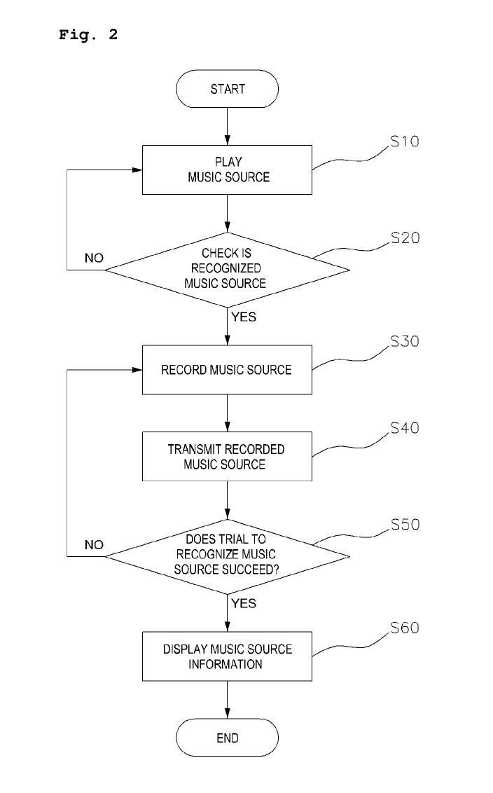

FIG. 1 illustrates a diagram of a music source information providing system through a media which is applied to a vehicle according to an exemplary embodiment of the present disclosure. FIG. 2 illustrates a flowchart of a music source information providing method through a media which is applied to a vehicle according to an exemplary embodiment of the present disclosure.

First, a media system 120 according to an exemplary embodiment of the present disclosure includes various media devices which are mounted in the vehicle and may include any one or more of an FM/AM/HD radio system, a USB/MP3/CD/Bluetooth music player system, and an AUX system.

In addition to the above-mentioned system, various types of systems which are capable of playing the music source in the vehicle may also be included.

The application program 200 corresponds to software which transmits the music source, which is recorded and transmitted from the media system 120, to a music source server 300 to receive information on the music source. An application program which is linked to the media system, that is, an application is representative thereof. In addition, an application program which is included in a terminal which is separately mounted in the vehicle to perform the above function may correspond thereto.

A procedure of the music source information providing method through a media which is applied to a vehicle according to an exemplary embodiment of the present disclosure will be described hereinafter.

First, the media system 120 of the vehicle plays the music source in step S10. The music source may be a music source which is played in the FM/AM/HD radio system, or a music source by the USB/MP3/CD/Bluetooth music player system, or a music source which is provided by the AUX system, as described above.

A driver or a passenger who listens to the music source and wants to know information on the music source may try to recognize the music source, and thus, the controller 110 of the vehicle checks whether the music source is recognized in step S20.

The step of checking whether or not the music source is recognized includes a step of displaying an icon by the media system 120. Whether the icon is touched or not is checked by the media system. A music source recognition trial signal is transmitted to the controller by the media system. A user tries to recognize the music source by clicking or touching the icon which is provided from the media system.

When the music source is not recognized, the media system 120 continuously plays the music source without taking a specific action. When the music source is recognized, the media system records the music source in step S30.

When music source recognition systems of the related art extract a music source sample required to recognize the music source, the music source sample is extracted through an external microphone. However, when the external microphone is used, not only the music source but also the noise is input through the microphone, thus reducing a success rate of music source recognition.

When the success rate of the music source recognition is reduced, the user may need to try again to recognize the music source, thus decreasing the user convenience. Therefore, according to the exemplary embodiment of the present disclosure, when the music source sample for recognizing the music source is extracted, the music source which is played in the media system 120 is directly recorded so as to prevent the external noise from being input and to increase the success rate of the music source recognition.

Thereafter, the media system 120 transmits the recorded music source to the application program 200 in step S40, and the application program tries to recognize the music source in step S50.

Here, recognizing the music source by the application program 200 includes a step of transmitting, music source data to the music source server 300 by the application program. Music source information is searched using the music source data by the music source server. The music source information is provided to the application program by the music source server.

The music source server 300 may be connected to database in which information on various music sources is stored to search the music source information. The music source information may include information on at least one of a title of the music source, a name of a singer of the music source, lyrics of the music source, an album title of the music source, and a year when the music source is released.

The system may be configured to select only desired information which is selected by the user, and the method of providing the information using the system is the same.

Next, when the music source is successfully recognized, the music source information is provided so that the media system 120 displays the music source information in step S60, and when the music source recognition fails, the media system records the music source again and repeats the same processes.

In order to try to recognize the music source according to the exemplary embodiment of the present disclosure, even though a separate central processing unit (CPU), which is connected to the media system 120 and is linked with the application program 200, may be required, the function may be performed using the CPU or a terminal control unit (TCU) which is provided in the vehicle of the related art.

According to the exemplary embodiments of the present disclosure, the music source recognition uses an internal signal of the media system 120 which is applied to a vehicle rather than using the external microphone so that the external noise is prevented from being introduced, thereby improving the quality of music source recording data and increasing a success rate of music source recognition as a result.

According to the exemplary embodiments of the present disclosure, no separate music source device which records a music source is required, and thus reducing the cost and easily being able to recognize the music source, thereby improving usability.

As described above, the present disclosure has been described in relation to specific embodiments of the present disclosure, but the embodiments are only illustrative, and the present disclosure is not limited thereto. Embodiments described may be changed or modified by those skilled in the art to which the present disclosure pertains without departing from the scope of the present invention, and various alterations and modifications are possible within the technical spirit of the present invention and the equivalent scope of the claims which will be described below.

What is claimed is:

1. A music source information providing method through a media for a vehicle, the method comprising steps of:
playing, by a media system which is provided in the vehicle, a music source;
checking, by a controller, whether or not the music source is recognized;
recording, by the media system, the music source when recognition of the music source is checked;
transmitting, by the media system, the recorded music source to an application program;
recognizing, by the application program, the music source; and
displaying, by the media system, music source information when the music source is recognized.

2. The method of claim 1, further comprising a step of:
recording, by the media system, after checking whether or not the music source is recognized, the music source again if the music source is not recognized.

3. The method of claim 1, wherein the media system includes any one or more of an FM/AM/HD radio system, a USB/MP3/CD/Bluetooth music player system, and an AUX system.

4. The method of claim 1, wherein the step of checking whether or not the music source is recognized includes steps of:
displaying, by the media system, an icon;
checking, by the media system, whether or not the icon is touched; and
transmitting, by the media system, a music source recognition signal to the controller.

5. The method of claim 1, wherein the step of recognizing the music source includes steps of:
transmitting, by the application program, music source data to a music source server;
searching, by the music source server, the music source information using the music source data; and
providing, by the music source server, the music source information to the application program.

6. The method of claim 1, wherein the music source information includes information on at least one of a title of the music source, a name of a singer of the music source, lyrics of the music source, an album title of the music source, and a year when the music source is released.

7. A non-transitory computer-readable medium including instructions execution of which causes the controller to perform the steps of claim 1.
